(19) United States
(12) Patent Application Publication
(10) Pub. No.: US 2013/0067680 A1
(43) Pub. Date: Mar. 21, 2013

(54) SUCTION AND COLLECTION DEVICE

(71) Applicant: Choji Yoshida, Osaka-Shi (JP)

(72) Inventor: Choji Yoshida, Osaka-Shi (JP)

(73) Assignee: SHARP KABUSHIKI KAISHA, Osaka-Shi, Osaka (JP)

(21) Appl. No.: 13/700,959

(22) PCT Filed: Jun. 2, 2011
(86) PCT No.: PCT/JP2011/062669

§ 371 Date: Nov. 29, 2012

(30) Foreign Application Priority Data
Jun. 11, 2010 (JP) 2010-133741
Mar. 16, 2011 (JP) 2011-057603

(51) Int. Cl. B08B 5/04

(52) U.S. Cl. CPC B08B 5/04
USPC 15/345

(57) ABSTRACT

Disclosed is a suction and collection device that sucks in and collects matter to be collected that is on top of a collection surface, by a suction means that has a suction inlet with an opening formed in the front section of a body housing. In said suction and collection device, the body housing is provided with a blowing means that has an outlet positioned lower than the suction inlet and that blows an air current along the collection surface from the outlet towards the front. The speed of the air current sucked into the suction inlet is made greater than the speed of the air current blown out of the outlet and the air current that is blown out of the outlet is sucked into the suction inlet.

### TECHNICAL FIELD

The present invention relates to a suction and collection device which collects matter to be collected, and the present invention specifically relates to a suction and collection device having suction means and blowing means.

### BACKGROUND ART

In general, electric cleaners and robot cleaners are commonly used as devices for sucking in and collecting dust. For example, electric cleaners have an electric blower disposed inside a body thereof, such that air containing dust is sucked in through a suction inlet by an operation of the blower. The sucked-in air is made to pass through a filter, which catches and collects dust contained in the air, and the air that has passed through the filter and from which the dust has been removed by the filter is discharged out of the electric cleaner. For improvement of dust suction efficiency, some of the electric cleaners are equipped with a function of circulating part of the air discharged therefrom and blowing out the circulated air from an outlet provided in a suction inlet.

A conventional suction and collection device is disclosed in Patent Literature 1.

In this suction and collection device, a jet nozzle is provided in an inlet port and the jet nozzle is connected to an air pump via a pipe portion. When an electric blower starts to operate, an air current is sucked in through a suction inlet. At the same time, compressed air starts to be accumulated in the air pump, to increase the pressure therein, and when the pressure reaches or exceeds a given level, a valve opens to let the compressed air current through the pipe portion to jet out from the jet nozzle. Then, the high-speed air current jetted out from the jet nozzle blows off dust existing on a surface to be cleaned or dust existing deep in a depression in the surface, and the thus blown off dust is sucked in through the inlet port. This makes it possible to collect dust efficiently.

### CITATION LIST

### Patent Literature

Patent Literature 1: JP-A-2001-321305

### SUMMARY OF INVENTION

### Technical Problem

However, in the conventional suction and collection device described above, the inlet port is disposed behind the jet nozzle in the direction in which the jet air current is discharged. With this arrangement, it is necessary to blow up dust high to suck in the dust through the inlet port, and this leads to a problem where part of dust fails to be sucked in through the inlet port and is scattered. Patent Literature 1 also discloses that an umbrella-like portion is provided at an opening to prevent dust from being scattered, but with such an arrangement, the umbrella-like portion collides against a wall in cleaning an area close to the wall, making it impossible to suck in dust existing by the wall.

In view of the above problems, an object of the present invention is to provide a suction and collection device capable of collecting matter to be collected without scattering it.

### Solution to Problem

To achieve the above object, according to one aspect of the present invention, in a suction and collection device which sucks in and collects matter to be collected existing on a dust-collection surface by using sucking means having a suction inlet opened in a front portion of a body housing, the body housing comprises blowing-out means having an outlet disposed below the suction inlet to blow out an air current through the outlet forward along the dust-collection surface; and a magnitude of speed of an air current sucked in through the suction inlet is larger than a magnitude of speed of an air current blown out through the outlet such that the air current blown out through the outlet is sucked in through the suction inlet.

To achieve the above object, according to another aspect of the present invention, in a suction and collection device which sucks in and collects matter to be collected existing on a dust-collection surface by using sucking means having a suction inlet opened in a front portion of a body housing, the body housing comprises blowing-out means having an outlet disposed below the suction inlet to blow out an air current through the outlet forward along the dust-collection surface; and a magnitude of volume of an air current sucked in through the suction inlet is larger than a magnitude of volume of an air current blown out through the outlet such that the air current blown out through the outlet is sucked in through the suction inlet.

According to these configurations, when the suction and collection device is driven, outside air is sucked in through the suction inlet formed in the front portion of the body housing, and the blowing-out means blows out air through the outlet to flow along the dust-collection surface. The matter to be collected that exists on the dust-collection surface is caught in the air current blown out through the outlet, and flows along the dust-collection surface. And, since the magnitude of the speed or volume of the air current sucked in through the suction inlet is larger than the speed or volume of the air current blown out through the outlet, the air current blown out through the outlet joins the air current to be sucked in to become part thereof, and is sucked in through the suction inlet.

According to a preferable embodiment of the present invention, it is preferable that the body housing be arranged to have a predetermined gap with respect to the dust-collection surface, and that the outlet be disposed behind the suction inlet such that an air current is blown out forward through the outlet to pass through the gap.

According to this configuration, when the suction and collection device is driven, an air current is blown out through the outlet to flow through the gap between the body housing and the dust-collection surface. Besides, since the outlet is disposed behind the suction inlet, the air current blown out through the outlet catches the matter to be collected existing in a rage between the body housing and the dust-collection surface that face each other. Then, the air current blown out through the outlet flows along the dust-collection surface to a point ahead of the body housing, and is sucked in through the suction inlet as part of sucked-in air.

To achieve the above object, according to another aspect of the present invention, in a suction and collection device which sucks in and collects matter to be collected existing on a dust-collection surface by using sucking means having a suction inlet opened in a body housing, the body housing comprises blowing-out means having an outlet disposed above the suction inlet and blows out an air current forward through the outlet toward the dust-collection surface; and a magnitude of speed of an air current sucked in through the suction inlet is larger than a magnitude of speed of an air current blown out through the outlet such that the air current blown out through the outlet is sucked in through the suction inlet.

To achieve the above object, according to another aspect of the present invention, in a suction and collection device which sucks in and collects matter to be collected existing on a dust-collection surface by using sucking means having a suction inlet opened in a body housing, the body housing comprises blowing-out means having an outlet disposed above the suction inlet to blow out an air current through the outlet forward along the dust-collection surface; and a magnitude of volume of an air current sucked in through the suction inlet is larger than a magnitude of volume of an air current blown out through the outlet such that the air current blown out through the outlet is sucked in through the suction inlet

According to a preferable embodiment of the present invention, in the above-configured suction and collection device, it is preferable that the suction inlet be formed in a front portion of the body housing.

According to a preferable embodiment of the present invention, in the above-configured suction and collection device, it is preferable that the suction inlet be disposed in a bottom surface of the body housing having a predetermined gap with respect to the dust-collection surface.

According to a preferable embodiment of the present invention, in the above-configured suction and collection device, it is preferable that the suction inlet be formed in a slit-like shape extending in a direction parallel to the dust-collection surface.

According to a preferable embodiment of the present invention, in the above-configured suction and collection device, it is preferable that a direction in which an air current to be sucked in through the suction inlet be substantially parallel to the dust-collection surface, and that an air current blown out through the outlet turn around ahead of the suction inlet to be sucked in through the suction inlet.

According to a preferable embodiment of the present invention, in the above-configured suction and collection device, it is preferable that the outlet comprise a plurality of outlets.

According to a preferable embodiment of the present invention, in the above-configured suction and collection device, it is preferable that the plurality of outlets be disposed opposite to each other such that an air current blown out through one of the outlets and an air current blown out through the other of the outlets collide against each other to be led forward.

According to a preferable embodiment of the present invention, in the above-configured suction and collection device, it is preferable that the air current blown out through the outlet include air discharged by the sucking-in means.

### Advantageous Effects of Invention

According to the present invention, the magnitude of speed or volume of an air current sucked in through a suction inlet is larger than the magnitude of speed or volume of an air current blown out through an outlet, and thus, the air current blown out through the outlet is sucked in through the suction inlet as part of an air current to be sucked in. Here, the blown-out air current catches the matter to be collected that exists on the dust-collecting surface, and joins the air current to be sucked in. Thus, it is possible to collect the matter to be collected that exists on the dust-collecting surface without scattering it.

### BRIEF DESCRIPTION OF DRAWINGS

FIG. 1 is a front view showing a suction and collection device according to a first embodiment of the present invention;

FIG. 2 is a side view showing the suction and collection device according to the first embodiment of the present invention;

FIG. 3 is a diagram analyzing distribution of movement vectors of air currents caused by the suction and collection device according to the first embodiment of the present invention;

FIG. 4 is a side view showing a suction and collection device according to a second embodiment of the present invention;

FIG. 5 is a front view showing a suction and collection device according to a third embodiment of the present invention;

FIG. 6 is a front view showing a suction and collection device according to a fourth embodiment of the present invention;

FIG. 7 is a side view showing a suction and collection device according to a fifth embodiment of the present invention;

FIG. 8 is a front view showing a suction and collection device according to a sixth embodiment of the present invention;

FIG. 9 is a side view showing the suction and collection device according to the sixth embodiment of the present invention;

FIG. 10 is a diagram analyzing stream lines of air currents caused at a dust-collection surface by the suction and collection device according to the sixth embodiment of the present invention;

FIG. 11 is a front view showing a suction and collection device according to a seventh embodiment of the present invention;

FIG. 12 is a side view showing the suction and collection device according to the seventh embodiment of the present invention;

FIG. 13 is a side view showing another example of the suction and collection device according to the first embodiment of the present invention;

FIG. 14 is a diagram analyzing stream lines of air currents observed when the suction and collection device according to the sixth embodiment of the present invention is used by a wall; and

FIG. 15 is a side view showing another example of the suction and collection device according to the sixth embodiment of the present invention.

### DESCRIPTION OF EMBODIMENTS

### First Embodiment

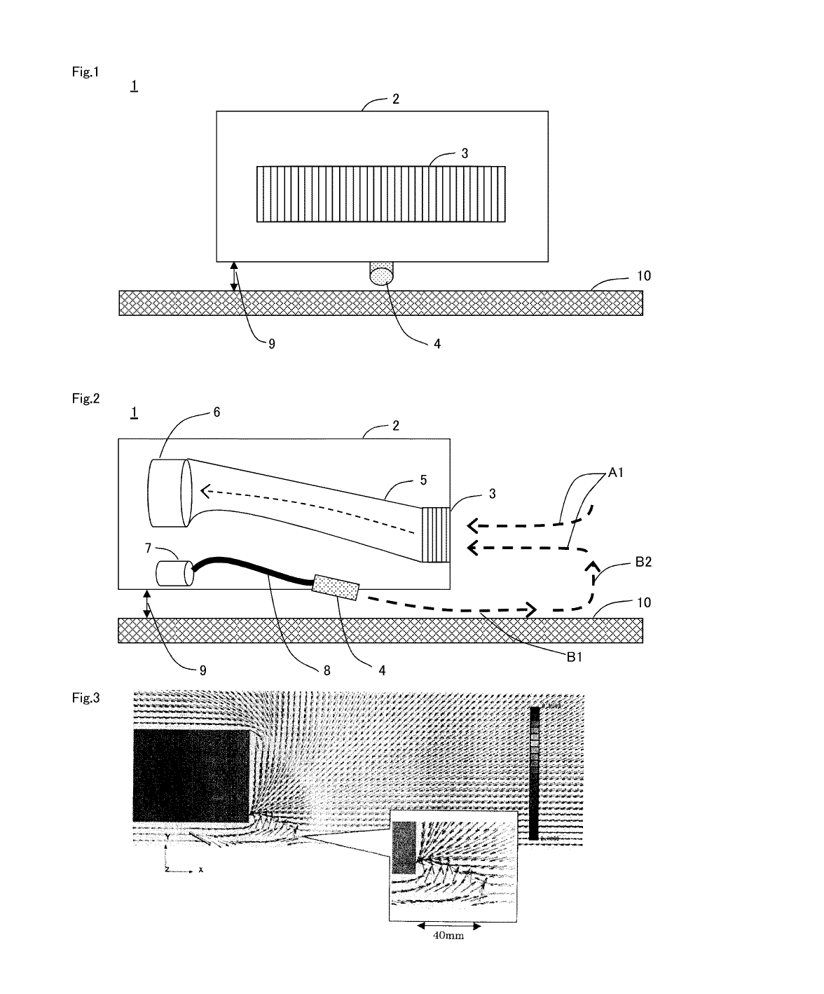

Embodiments of the present invention will be described below with reference to the accompanying drawings. However, the following embodiments are merely examples of the suction and collection device of the present invention presented to specify the technical idea of the present invention, and it is not intended to limit the present invention to the following suction and collection devices. The present invention has equivalent applicability to other embodiments of a suction and collection device included in the scope of the claims. Furthermore, numeric values specifically dealt with hereinafter are just examples, and they are not meant to limit the scope of the present invention in any manner. FIGS. 1 and 2 are a front view and a side view, respectively, showing a suction and collection device according to a first embodiment of the present invention. The suction and collection device 1 is provided with a body housing 2 which collects matter to be collected. The body housing 2 of the suction and collection device 1 is arranged with a gap 9 of a predetermined dimension from a surface 10 from which dust is to be collected (hereinafter, a dust-collection surface 10). And a suction inlet 3 is provided in a front surface 2a of the body housing 2 which is perpendicular to the dust-collection surface 10, and an outlet 4 is disposed at a position that is behind and below the suction inlet 3. For the purpose of sucking in outside air from a wide range, the suction inlet 3 is formed extending in a direction substantially parallel to the dust-collection surface 10 to open wide in the lateral direction of the front surface 2a. The outlet 4 is formed opening in a spot-like manner so that an air current can blow to the dust-collection surface 10 at a given speed.

The suction inlet 3 is connected to an electric blower 6 via a suction passage 5.

Thereby, the suction inlet 3, the suction passage 5, and the electric blower 6 form suction means which sucks in, through the suction inlet 3, outside air together with matter to be collected. The outlet 4 is opened to face the same direction as the suction inlet 3. Besides, the outlet 4 is slightly inclined toward the dust-collection surface 10 to blow an air current along the dust-collection surface 10. The outlet 4 is connected to an air pump 7 via a pipe portion 8. Thereby, the outlet 4, the pipe portion 8, and the air pump 7 form blowing means which blows an air current through the outlet 4 along the dust-collection surface 10. Note that the air pump 7 compresses air from which matter to be collected, such as dust, has been removed by an unillustrated filter.

In the suction and collection device 1 configured as described above, when the electric blower 6 is driven, outside air is sucked in through the suction inlet 3 at a given speed as indicated by an arrow A1. Furthermore, air compressed by the air pump 7 is blown out from the outlet 4 at a given speed as indicated by an arrow B1. The air current blown out through the outlet 4 passes through the gap 9 between the body housing 2 and the dust-collection surface 10. In passing through the gap 9 between the body housing 2 and the dust-collection surface 10, the air current blown out from the outlet 4 catches matter to be collected existing on the dust-collection surface 10 under the body housing 2, and moves toward ahead of the suction inlet 3.

At this time, the magnitude of speed of the air current sucked in through the suction inlet 3 is set to be larger than that of the air current blown out through the outlet 4. Thereby, air circulation is generated within a certain range including the suction inlet 3 and the outlet 4, and as a result, the direction of the movement vector of the air current blown out through the outlet 4, which flows along the dust-collection surface 10, is upwardly changed as indicated by an arrow B2. And the air current blown out through the outlet 4 enters the suction passage 5 as part of the air current sucked in through the suction inlet 3. In this way, dust existing on the dust-collection surface 10 is caught in the air current and collected.

In addition, the air current blown out from the outlet 4 passes through the gap 9 between the body housing 2 and the dust-collection surface 10, catching the matter to be collected existing in the gap 9, to blow the matter toward ahead of the suction inlet 3, and this makes it possible to collect the matter to be collected without scattering it.

It should be noted that there is no specific limitation as to where in the area that is behind and below the suction inlet 3 the outlet 4 should be disposed. As shown in FIG. 13, by making the air current blown out through the outlet 4 take a longer time (move a longer distance) to pass through the gap 9 between the body housing 2 and the dust-collection surface 10, it is possible to make the air current catch the matter to be collected in a wider range of the gap 9 and blow the matter toward ahead of the suction inlet 3 to thereby collect a large amount of matter to be collected without scattering it.

FIG. 3 is a diagram analyzing distribution of movement vectors of air currents in a case where a predetermined speed difference was set. Here, the speed of a sucked-in air current was set to 17 m/s, while the speed of a blown-out air current was set to 10 m/s, so that the speed difference was 7 m/s. With this setting, it was observed that the direction of the movement vector of the blown-out air current was upwardly changed at a point about 40 mm ahead of the suction inlet 3 to join an air current to be sucked in. Thus, it can be said that a range extending 40 mm ahead from the suction inlet 3 was a dust-collection range.

Note that the dust-collection range can be set freely by changing the magnitude of the speed of the air current passing through the outlet 4 and that of the air current passing through the suction inlet 3, and by changing the speed difference.

Furthermore, a suction operation was conducted with expanded beads having a diameter of 2 mm and placed on a wooden floor as the dust-collection surface 10, under a condition where the speed of the sucked-in air current was set to 17 m/s and that of the blown-out air current was set to 10 m/s. As a result, all the matter to be collected was able to be sucked in without being scattered in a dust-collection range extending 40 mm ahead from the suction inlet 3 and 10 mm wide.

According to the present embodiment, as a result of the magnitude of the speed of the air current sucked in through the suction inlet 3 being larger than that of the air current blown out through the outlet 4, the air current blown out through the outlet 4 is sucked in through the suction inlet 3 as part of the sucked-in air current. At this time, the blown-out air current catches the matter to be collected existing on the dust-collection surface 10, and joins the air current to be sucked in. Thus, it is possible to collect the matter to be collected existing on the dust-collection surface 10 without scattering it.

Moreover, the air current that is to be sucked in through the suction inlet 3 is made to flow over the dust-collection surface 10 substantially parallelly with respect to the dust-collection surface 10, and thus the air current blown out through the outlet 4 changes its direction at a point ahead of the suction inlet 3 to be sucked in through the suction inlet 3. This makes it possible to set the dust-collection range to a certain range extending in front of the suction inlet 3, and thus to collect dust existing in an open space in front of the body housing 2.

### Second Embodiment

FIG. 4 is a side view showing a suction and collection device according to a second embodiment. For the sake of convenience of description, such parts as find their counterparts in the first embodiment shown in the above referred-to FIGS. 1 and 2 are identified by common reference signs. The present embodiment does not have a predetermined gap 9 between a body housing 2 of a suction and collection device 1 and a dust-collection surface 10, and an outlet 4 is disposed below a suction inlet 3. In the other respects, the present embodiment is similar to the first embodiment.

With the present embodiment, as with the first embodiment, it is possible to collect matter to be collected existing on the dust-collection surface 10 without scattering it.

### Third Embodiment

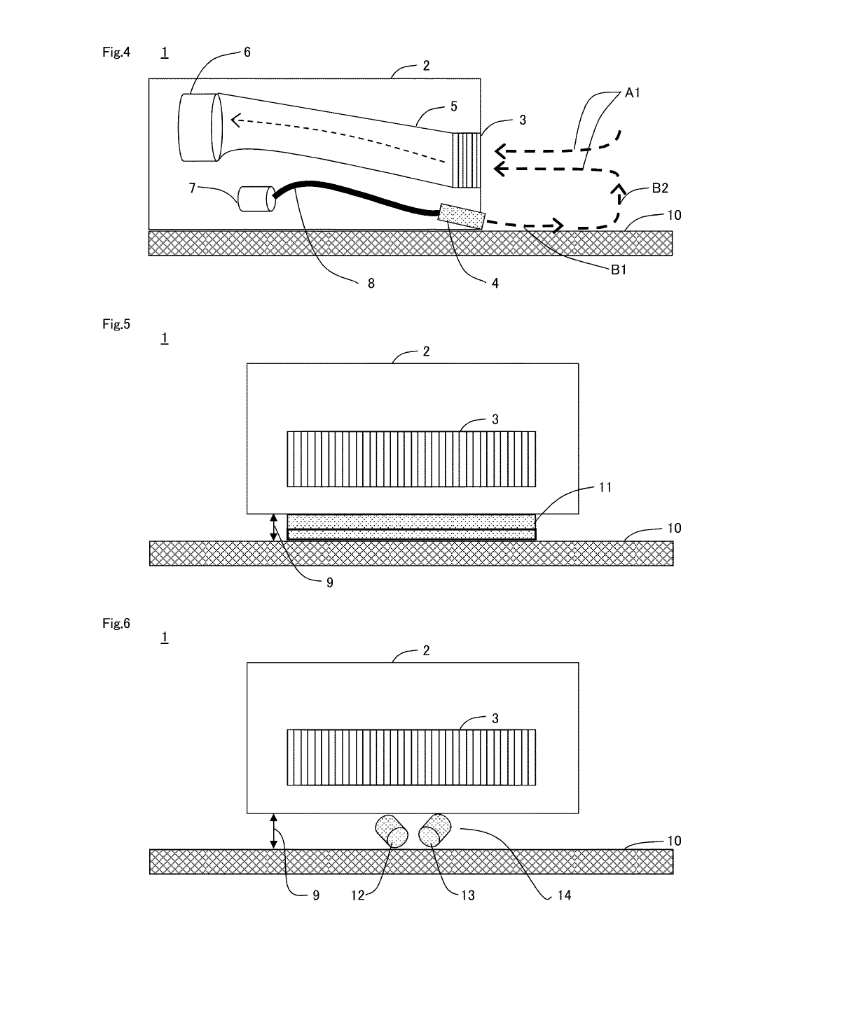

FIG. 5 is a front view showing a suction and collection device according to a third embodiment. For the sake of convenience of description, such parts as find their counterparts in the first embodiment shown in the above referred-to FIGS. 1 and 2 are identified by common reference signs. In the present embodiment, an outlet 11 of a suction and collection device 1 is formed as a slit extending in a direction that is parallel with respect to a dust-collection surface 10. In the other respects, the present embodiment is similar to the first embodiment.

With the present embodiment, it is possible to obtain the same effects as can be obtained with the first embodiment. In addition, with the outlet 4 that is formed as a slit extending in the direction that is parallel with respect to the dust-collection surface 10, it is possible to blow out a wide air current toward the dust-collection surface 10. As a result, air current flows over the dust-collection surface 10 in a laterally wide range, so that a large amount of matter to be collected existing on the dust-collection surface 10 can be caught in the air current, and thereby, it is possible to improve dust suction efficiency.

### Fourth Embodiment

FIG. 6 is a front view showing a suction and collection device according to a fourth embodiment. For the sake of convenience of description, such parts as find their counterparts in the first embodiment shown in the above referred-to FIGS. 1 and 2 are identified by common reference signs. In the present embodiment, an outlet 14 of a suction and collection device 1 is composed of a first outlet 12 and a second outlet 13, both having a shape opening in a spot-like manner. In the other respects, the present embodiment is similar to the first embodiment.

The first outlet 12 and the second outlet 13 are arranged opposite to each other such that air currents blown out from the first and second outlets 12 and 13 collide against each other to be led frontward. Here, it is preferable that the air currents collide against each other at a point that is located ahead of the suction inlet 3 and also away from a body housing 2 such that the directions of the movement vectors of the air currents are upwardly changed when the air currents collide against each other.

In the suction and collection device 1 configured as described above, when an electric blower 6 is driven, an air current blown out through the first outlet 12 and an air current blown out through the second outlet 13 collide against each other, and thereby, a force is generated to upwardly change the directions of the movement vectors of the air currents.

According to the present embodiment, it is possible to obtain the same effects as can be obtained with the first embodiment. In addition, it is possible to upwardly change the directions of the movement vectors of the air currents efficiently with a less amount of air, and this in turn makes it possible to use a less expensive air pump 7 (see FIG. 1). Thus, it is possible not only to reduce the cost of the suction and collection device 1, but also to reduce power consumption. Incidentally, in the first to fourth embodiments, a blower fan may be provided instead of the air pump 7.

### Fifth Embodiment

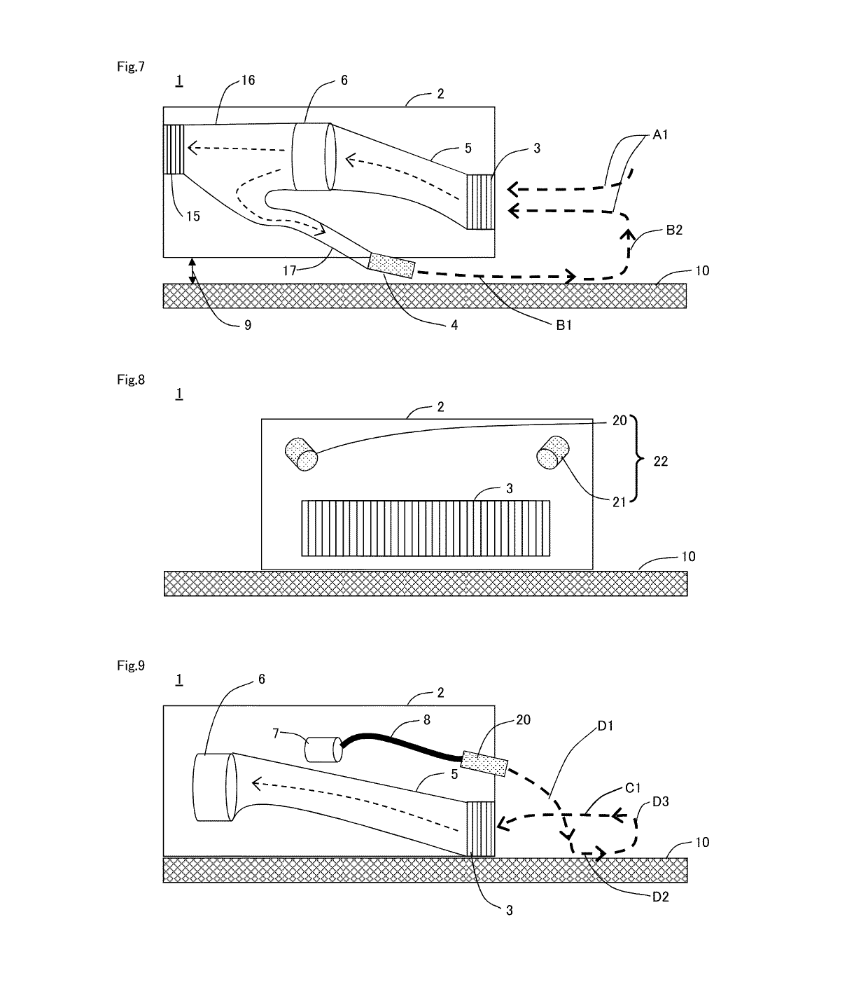

FIG. 7 is a side view showing a suction and collection device according to a second embodiment. For the sake of convenience of description, such parts as find their counterparts in the first embodiment shown in the above referred-to FIGS. 1 and 2 are identified by common reference signs. An air discharge port 15 is provided on a rear surface side of a suction and collection device 1, and an electric blower 6 and the air discharge port 15 are connected with each other by an air discharge duct 16. Furthermore, an air pump 7 (see FIG. 1) is not provided, but instead, there is provided a pipe portion 17 diverging from the air discharge duct 16, and the electric blower 6 and an outlet 4 are connected with each other via the pipe portion 17. In the other respects, the present embodiment is similar to the first embodiment.

In the suction and collection device 1 configured as described above, when the electric blower 6 is driven, outside air is sucked in through a suction inlet 3 at a given speed. The outside air sucked in through the suction inlet 3 passes through an unillustrated filter, where matter to be collected caught in the outside air is removed therefrom, and then the air passes through the air discharge duct 16 to be discharged through the air discharge port 15. Part of the air discharged by the electric blower 6 flows through the pipe portion 17 diverging from the air discharge duct 16, to be blown out from the outlet 4.

With the present embodiment, as with the first embodiment, it is possible to collect the matter to be collected existing on the dust-collecting surface 10 without scattering it. In addition, since part of the air discharged by the electric blower 6 can be used to blow out an air current through the outlet 4, there is no need of providing a blowing machine such as an air pump, and this contributes to reduction of the number of components, and thus, to cost reduction. Besides, since consumption of electric power can be reduced by the amount that would be necessary to drive a blowing machine such as an air pump, it is possible to achieve a power saving suction and collection device. It is also possible to achieve a lightweight device.

The present embodiment has the air discharge port 15 to thereby achieve a setting where the magnitude of the speed of the sucked-in air current is set to be larger than that of the blown-out air current; however, if the above object is able to be achieved by changing the shapes of the suction inlet 3 and the outlet 4, the air discharge port 15 is not indispensable.

### Sixth Embodiment

FIGS. 8 and 9 are a front view and a side view, respectively, showing a suction and collection device according to a sixth embodiment of the present invention. For the sake of convenience of description, such parts as find their counterparts in the first embodiment shown in the above referred-to FIGS. 1 and 2 are identified by common reference signs. In the present embodiment, an outlet 22 of a suction and collection device 1 is composed of a first outlet 20 and a second outlet 21, both having a shape that is opened in a spot-like manner. In addition, the first outlet 20 and the second outlet 21 are both disposed above a suction inlet 3. Like the fourth embodiment, the present embodiment does not have a predetermined gap 9 between the body housing 2 and a dust-collecting surface 10; however, the present invention may have a predetermined gap 9. In the other respects, the present embodiment is similar to the first embodiment.

In the suction and collection device 1 configured as described above, when an electric blower 6 is driven, outside air is sucked in through the suction inlet 3 at a given speed as indicated by an arrow C1. Furthermore, air compressed by an air pump 7 is blown out through the first and second outlets 20 and 21 toward the dust-collection surface 10 at a given speed as indicated by an arrow D1.

At this time, the magnitude of the speed of an air current sucked in through the suction inlet 3 is set to be larger than that of air currents blown out through the first and second outlets 20 and 21. Thereby, a circulation of air is generated within a certain range including the suction inlet 3 and the first and second outlets 20 and 21.

In more detail, with reference to FIG. 9, the direction of the movement vector of the air current that has reached (collided with) the dust-collection surface 10 is changed to a direction toward ahead of the suction inlet 3 as indicated by an arrow D2, and the air current flows along the dust-collecting surface 10. Then, after the air current flows a predetermined distance along the dust-collection surface 10, the direction of the movement vector of the air current is changed, as indicated by an arrow D3, to a direction toward the suction inlet 3. And, the air currents blown out through the first and second outlets 20 and 21 enter the suction passage 5 as part of the air current sucked in through the suction inlet 3. In this way, dust on the dust-collecting surface 10 is included in the air current and collected thereby.

That is, since the air currents that have been blown out through the first and second outlets 20 and 21 catch the matter to be collected existing ahead of a body housing 2 and the dust-collection surface 10 when the air currents join, and become part of, an air current to be sucked in through the suction inlet 3, it is possible to collect the matter to be collected without scattering it.

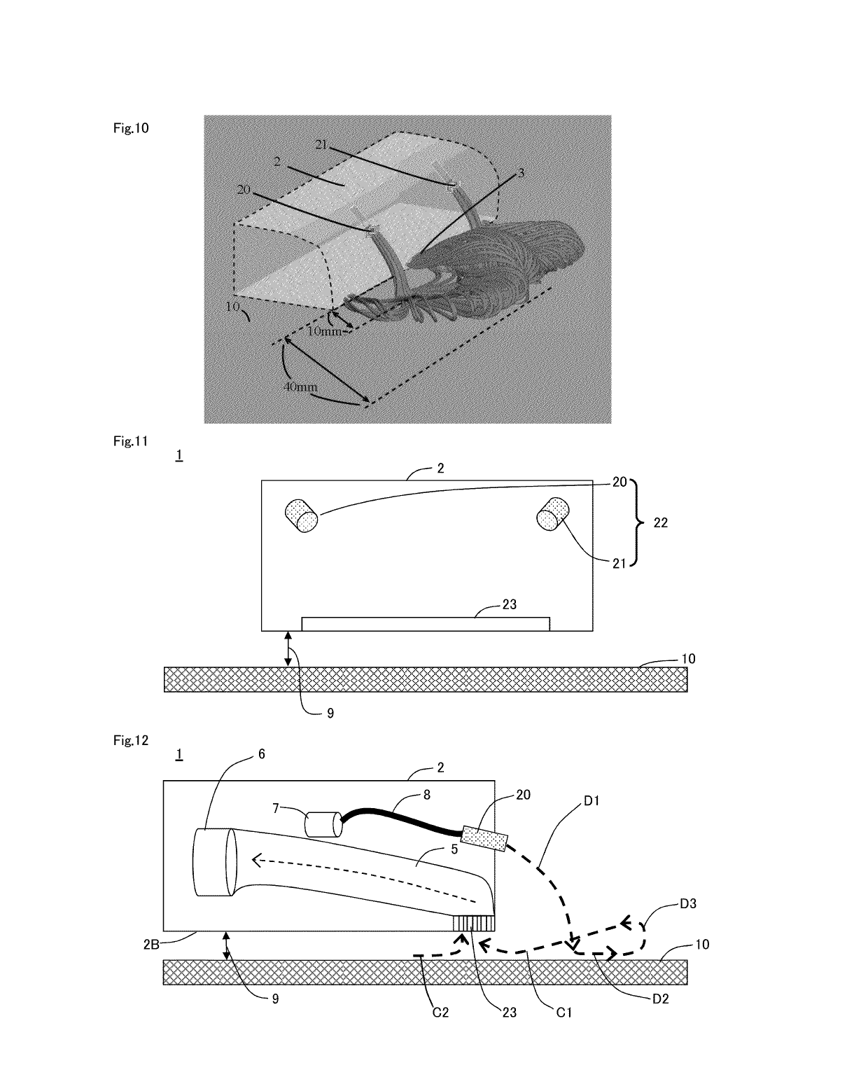

FIG. 10 is a diagram analyzing stream lines of air currents caused at the dust-collection surface 10 by the suction and collection device according to the present embodiment. As shown in FIG. 10, the air currents blown out through the first and second outlets 20 and 21 reach (collide against) the dust-collecting surface 10 in the vicinity of 10 mm ahead of the suction inlet 3. And, the air currents that have reached (collided against) the dust-collecting surface 10 flow about 30 mm toward ahead of the suction inlet 3 along the dust-collecting surface 10.

On the other hand, as described above, since air circulation has been generated in the predetermined range including the suction inlet 3 and the first and second outlets 20 and 21, at a point in the vicinity of 40 mm ahead of the suction inlet 3, the directions of the movement vectors of the air currents from the first and second outlets 20 and 21 are changed to a direction toward the suction inlet 3 such that the air currents join the air current to be sucked in through the suction inlet 3. In this case, in the vicinity of 40 mm ahead of the suction inlet 3, no movement vector of an air current is generated in a direction in which the matter to be collected would be scattered (a direction opposite from the suction inlet 3). Thus, in the vicinity of 40 mm ahead of the suction inlet 3, movement vectors are generated only in the direction toward the suction inlet 3, and thus, it is possible to collect the matter to be collected existing on the dust-collecting surface 10 without scattering it.

Note that, to make it easier for the directions of the movement vectors of the air currents blown out through the first and second outlets 20 and 21 to be changed to a downward direction, the first and second outlets 20 and 21 may be disposed opposite to each other such that the air currents blown out through the first and second outlets 20 and 21 collide against each other, to be led forward. Here, it is preferable that the air currents collide against each other at a point that is located ahead of the suction inlet 3 and also away from a body housing 2 such that the directions of the movement vectors of the air currents are upwardly changed when the air currents collide against each other.

According to the present embodiment, like the first embodiment, it is possible to collect the matter to be collected existing on the dust-collecting surface 10 without scattering it. The outlet 22 of the present embodiment is composed of two outlets (the first outlet 20 and the second outlet 21), but the outlet 22 may be formed as a single outlet (the outlet 1 of the first embodiment).

### Seventh Embodiment

FIGS. 11 and 12 are a front view and a side view, respectively, showing a suction and collection device according to a seventh embodiment. For the sake of convenience of description, such parts as find their counterparts in the first embodiment shown in the above referred-to FIGS. 1 and 2 are identified by common reference signs. In the present embodiment, an outlet 22 of a suction and collection device 1 is composed of a first outlet 20 and a second outlet 21, both having a shape that is opened in a spot-like manner. In addition, the first outlet 20 and the second outlet 21 are both disposed above a suction inlet 23. In addition, the suction inlet 23 is formed in a bottom surface 2B of a body housing 2. In the other respects, the present embodiment is similar to the first embodiment.

Since the suction inlet 23 is formed in the bottom surface 2B of the body housing 2, an air current sucked in through the suction inlet 23 includes not only air currents (indicated by the arrow C1) blown out through the first and second outlets 20 and 21, but also an air current (indicated by the arrow C2) that flows, through a gap between a dust-collection surface 10 and the body housing 2, from behind the suction inlet 23 toward the suction inlet 23.

This makes it possible for the air current to catch matter to be collected existing behind the suction inlet 23, in the gap between the dust-collection surface 10 and the body housing 2, to thereby collect the matter through the suction inlet 23.

With the present embodiment, as with the first embodiment, it is possible to collect the matter to be collected existing on the dust-collecting surface 10 without scattering it. In addition, since the suction inlet 23 is disposed in the bottom surface 2B of the body housing 2, it is possible to efficiently collect the matter to be collected such as dust from not only ahead of, but also behind, the suction inlet 23. Incidentally, in the sixth and seventh embodiments, a blower fan may be provided instead of an air pump 7. Or, as shown in the fifth embodiment, the sixth and seventh embodiments may be configured without an air pump 7.

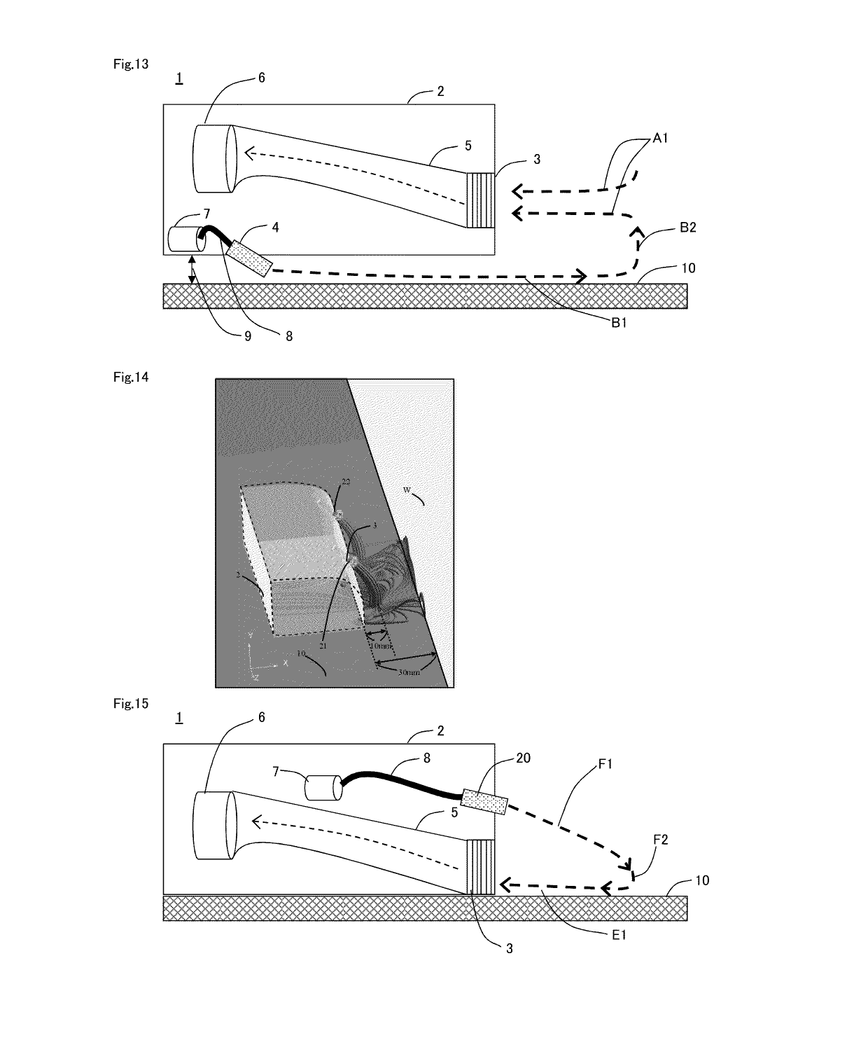

In the sixth and seventh embodiments, the point where the air current blown out through the outlet 22 (the first and second outlets 20 and 21) reaches the dust-collection surface is farther ahead of the suction inlet 3 or 23 than the point where the direction of the movement vector of the air current blown out through the outlet 22 is changed to a direction toward the suction inlet 3 or 23; however, as in another example of the sixth embodiment shown in FIG. 15, for example, the point where the air current blown out through the outlet 22 reaches the dust-collection surface and the point where the direction of the movement vector of the air current blown out through the outlet 22 is changed to the direction toward the suction inlet 3 or 23 may be substantially the same.

That is, the direction of the movement vector of the air current blown out through the outlet 22 towards the dust-collecting surface 10 at a given speed as indicated by an arrow F 1 may be changed to a direction toward the suction inlet 3 as indicated by an arrow F2 when the air current reaches the dust-collecting surface 10. Thereafter, the air current blown out through the outlet 22 becomes part of an air current that is to be sucked in through the suction inlet 3 at a given speed as indicated by an arrow E1.

[Description of Air current Speed and Volume]

In the embodiments described above, as to the speeds of air currents passing through the outlets and suction inlets, the magnitude of the speed of the air current sucked in through a suction inlet is set larger than the magnitude of the speed of the air current blown out through an outlet (outlet air current speed<suction inlet air current speed). This translates into that the volume of the air current sucked in through a suction inlet is larger than that of the air current blown out through an outlet.

This is because the volume of an air current is calculated by multiplying the sectional-area of an outlet or a suction inlet by the speed of the air current (wind speed) (air current volume=sectional area×wind speed). That is, as shown in the drawings, the sectional-areas of the suction inlets are larger than those of the outlets, and further, as described above, the magnitudes of the speeds of air currents (wind speeds) sucked in through the suction inlets are larger than those of the speeds of air currents (wind speeds) blown out from the outlets; thus, the volumes of the air currents sucked in through suction inlets are larger than those of the air currents blown out from the outlet.

A desired air current volume can be obtained by adjusting the sectional-area and/or the speed of an air current (wind speed). As described above, the air current volume may be made larger at the suction inlets than at the outlets by making the sectional-areas of, and the air current speeds (wind speeds) at, the suction inlets both greater than the sectional-areas of, and the air current speeds (wind speeds) at, the outlets; or, the air current volume may be made larger at the suction inlets than at the outlets by, for example, making the air current speeds (wind speeds) at the suction inlets smaller than those at the outlets while making the sectional-areas of the suction inlets larger than those of the outlets. Incidentally, the suction and collection device of the sixth embodiment is set such that the volume of the air current sucked in through the suction inlet 3 is 0.5 m³/min, and that of the air current blown out from the outlet 22 is 0.002 m³/min.

### [Description of the Dust Collecting Effect by a Wall]

FIG. 14 is a diagram analyzing stream lines of air currents observed when a suction and collection device of the present invention is used by a wall. In FIG. 14, the suction and collection device is the suction and collection device 1 of the sixth embodiment, but the same dust collecting effect can be exerted by using the suction and collection devices 1 of the other embodiments, too.

In FIG. 14, the distance between the suction inlet 3 and a wall surface W is 30 mm. Air currents blown out from the first and second outlets 20 and 21 reach the dust-collection surface 10 at a point that is about 10 mm ahead of the suction inlet 3, and then flow along the dust-collection surface 10 toward ahead of the suction inlet 3. Besides, the air currents flowing along the dust-collection surface 10 reach (collide against) the wall surface W, when the directions of the movement vectors of the air currents are changed to an opposite direction (a direction toward the suction inlet 3). Then, the air currents, after the directions of the movement vectors thereof are changed to the direction toward the suction inlet 3, join an air current that is to be sucked in through the suction inlet 3. As a result, it is possible to efficiently collect matter to be collected existing at places by the wall, in a corner, or at a corner, which are difficult to clean, without scattering the matter to be collected.

### INDUSTRIAL APPLICABILITY

The present invention is applicable to a suction and collection device having means for blowing out an air current and means for sucking in an air current.

### LIST OF REFERENCE SYMBOLS

1 suction and collection device
2 housing
3, 23 suction inlet
4, 11, 14, 22 outlet
5 suction passage
6 electric blower
7 air pump
8, 17 pipe portion
9 gap
10 dust-collection surface
12, 20 first outlet
13, 21 second outlet
15 air discharge port
16 air discharge duct

1-12. (canceled)

13. A suction and collection device, comprising:
a body housing;
a suction unit having a suction inlet opened in a front portion of the body housing; and
a blower unit having an outlet disposed below the suction inlet to blow out an air current through the outlet forward along a dust-collection surface;
wherein
a magnitude of speed of an air current sucked in through the suction inlet is larger than a magnitude of speed of an air current blown out through the outlet such that the air current blown out through the outlet is sucked in through the suction inlet.

14. A suction and collection device, comprising:
a body housing;
a suction unit having a suction inlet opened in a front portion of the body housing; and
a blower unit having an outlet disposed below the suction inlet to blow out an air current through the outlet forward along a dust-collection surface,
wherein
a magnitude of volume of an air current sucked in through the suction inlet is larger than
a magnitude of volume of an air current blown out through the outlet such that the air current blown out through the outlet is sucked in through the suction inlet.

15. The suction and collection device according to claim 13,
wherein
the body housing is arranged such that there is a predetermined gap between the body housing and the dust-collecting surface;
the outlet is disposed behind the suction inlet; and
an air current is blown out forward through the outlet to pass through the gap.

16. The suction and collection device according to claim 14,
wherein
the body housing is arranged such that there is a predetermined gap between the body housing and the dust-collecting surface;
the outlet is disposed behind the suction inlet; and
an air current is blown out forward through the outlet to pass through the gap.

17. A suction and collection device, comprising:
a body housing;
a suction unit having a suction inlet opened in a front portion of the body housing; and
a blower unit having an outlet disposed above the suction inlet and blows out an air current forward through the outlet toward the dust-collection surface,
wherein
a magnitude of volume of an air current sucked in through the suction inlet is larger than a magnitude of volume of an air current blown out through the outlet such that the air current blown out through the outlet is sucked in through the suction inlet.

18. The suction and collection device according to claim 17,
wherein
the suction inlet is formed in a front portion of the body housing.

19. The suction and collection device according to claim 17,
wherein
the suction inlet is disposed in a bottom surface of the body housing which is arranged such that there is a predetermined gap between the body housing and the dust-collection surface.

20. The suction and collection device according to claim 13,
wherein
the suction inlet is formed in a slit-like shape extending in a direction parallel to the dust-collection surface.

21. The suction and collection device according to claim 14,
wherein
the suction inlet is formed in a slit-like shape extending in a direction parallel to the dust-collection surface.

22. The suction and collection device according to claim 17,
wherein
the suction inlet is formed in a slit-like shape extending in a direction parallel to the dust-collection surface.

23. The suction and collection device according to claim 13,
wherein
a direction in which an air current to be sucked in through the suction inlet is substantially parallel to the dust-collection surface, and an air current blown out through the outlet turns around ahead of the suction inlet to be sucked in through the suction inlet.

24. The suction and collection device according to claim 14,
wherein
a direction in which an air current to be sucked in through the suction inlet is substantially parallel to the dust-collection surface, and an air current blown out through the outlet turns around ahead of the suction inlet to be sucked in through the suction inlet.

25. The suction and collection device according to claim 17,
wherein
a direction in which an air current to be sucked in through the suction inlet is substantially parallel to the dust-collection surface, and an air current blown out through the outlet turns around ahead of the suction inlet to be sucked in through the suction inlet.

26. The suction and collection device according to claim 13,
wherein
the outlet comprises a plurality of outlets.

27. The suction and collection device according to claim 14,
wherein
the outlet comprises a plurality of outlets.

28. The suction and collection device according to claim 17,
wherein
the outlet comprises a plurality of outlets.

29. The suction and collection device according to claim 26,
wherein
the plurality of outlets are disposed opposite to each other such that an air current blown out through one of the outlets and an air current blown out through another of the outlets collide against each other to be led forward.

30. The suction and collection device according to claim 27,
wherein
the plurality of outlets are disposed opposite to each other such that an air current blown out through one of the outlets and an air current blown out through another of the outlets collide against each other to be led forward.

31. The suction and collection device according to claim 28,
wherein
the plurality of outlets are disposed opposite to each other such that an air current blown out through one of the outlets and an air current blown out through another of the outlets collide against each other to be led forward.

32. The suction and collection device according to claim 14,
wherein
the air current blown out through the outlet includes air discharged by the suction unit.
